(19) United States
(12) Patent Application Publication
(10) Pub. No.: US 2023/0169846 A1
(43) Pub. Date: Jun. 1, 2023

(54) LAW ENFORCEMENT COMMUNICATION SYSTEM AND DEVICE

(71) Applicant: Trilemma Solutions, Inc., Jacksonville, FL (US)

(72) Inventor: Arthur F. Butler, St. Augustine, FL (US)

(73) Assignee: Trilemma Solutions, Inc., Jacksonville, FL (US)

(21) Appl. No.: 18/060,346

(22) Filed: Nov. 30, 2022

Related U.S. Application Data
(60) Provisional application No. 63/284,337, filed on Nov. 30, 2021.

(51) Int. Cl. G08B 25/01

(52) U.S. Cl. CPC G08B 25/014

(57) ABSTRACT

A system for communication facilitation between parties to an interaction is provided. The system may include communication devices in communication with one another via a communication server. The communication devices may each include a speaker, a microphone, a display, a camera, and an input interface. The communication server may include a server database that may store information regarding users of the communication devices. Upon a determination being made that a user of the communication devices is pulled over by law enforcement, the communication server may transmit a least a portion of the information to one or more of the communication devices. The communication server may monitor and mediate the communication between the communication devices.

### RELATED APPLICATIONS

This application claims priority under 35 U.S.C. § 119(e) of U.S. Provisional Patent Application Ser. No. 63/284,337 (Attorney Docket No. 6085.00001) filed on Nov. 30, 2021 and titled LAW ENFORCEMENT COMMUNICATION SYSTEM AND DEVICE. The content of this application is incorporated herein by reference.

### FIELD OF THE INVENTION

The present invention relates to systems and methods to reduce adverse confrontation between law enforcement and drivers and, more specifically, to a system that allows for law enforcement and drivers to communicate with one another through a third party.

### BACKGROUND OF THE INVENTION

Various issues relating to the interactions between two or more parties in situations with a risk of danger, miscommunication, confrontation, inefficiency, or unaccountability are known in the art. Accordingly, there is a need in the art for an improved system or method to facilitate improved communications between parties.

It is often an issue and dilemma that interactions between two or more parties to an interaction involving communication, especially in stressful situations, that there is a great chance for miscommunication, misunderstanding, deceit, confrontation, and sometimes danger. A system that can help alleviate the chances of any of the above from happening around these multiple-party interactions has not been developed in the prior art, especially for interactions between law enforcement and citizens and/or suspects. It is desirable for the system to provide an avenue for the parties to communicate concisely, with accountability, and with potential for a third party disinterested party provided to facilitate the interaction. The system would also need to be easily accessible, available, and user friendly much like the applications individuals use on smart phones or on a car's computer system.

For example, in cases of a traffic stop, there can be miscommunication between a law enforcement officer and a citizen (driver and/or passenger in the vehicle), and these miscommunications can sometimes lead to undesired outcomes. In other words, in the case of a traffic stop, where a situation can be readily resolved with the issuance of a citation, based on a miscommunication, or misperception of the situation, the otherwise routine traffic stop can become a violent situation where people are endangered. There is a need for a system that can prevent such miscommunications from occurring.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

The embodiments of the present invention are related to systems and methods of mediating interactions between two parties. The present invention provides a system for communication facilitation between parties to an interaction. The system may comprise at least two communication devices in communication with one another and with a communication server. The communication devices may include a speaker, a microphone, a display, a camera, and an input interface. The communication server may include a server database that may store a plurality relevant information regarding at least one of the users of the communication devices. The communication devices may be configured to determine when a user is pulled over by law enforcement. Upon a communication device determining that a user is pulled over by law enforcement, the communication server may transmit relevant information regarding the user to one or more of the communication devices. The communication server may monitor and mediate the communication between the communication devices.

In one embodiment of the present invention, the system may include a communication server and a database server configured to advantageously mediate communications and record interactions between drivers that have been pulled over and a law enforcement officer who has pulled the driver over. The database server and communications server may also be configured to store and disseminate relevant information to the driver and the law enforcement officer such as, for example, without limitation, the driver's insurance information, driver's license number, why the driver has been pulled over, and whether the driver has any outstanding warrants, or any other type of information that may be relevant during a typical vehicle stop made by law enforcement.

The computer-implemented system and method may function to filter and mediate communications between two parties in a situation where an adversarial confrontation is possible. Although it is recognized that not every interaction between law enforcement and a driver or citizens/civilians is adversarial in nature, some of these interactions have potential to become adversarial and, as such, the system and methods according to the present invention advantageously help to diffuse any such situation by introducing a third party to communicate and mediate between the law enforcement officer and the civilian. Further, the present invention advantageously provides an accountability system for both the law enforcement officer and the driver to hold themselves and each other accountable.

The system may advantageously include a communication server, a communication network, a server database, a device comprising a plurality of components, and, in some cases, a vehicle or a vehicle associated with the device. The device and associated vehicle may be configured to relay communications to each other through the communication network with the communication server acting as an intermediary for the communications. The communication server may be configured to filter the communications between law enforcement and the driver, and to mediate those communications. The communication server may also be configured to provide recommendations to both the driver and the officer as to the best response or communication to make. The server database may be configured to store relevant information on the parties involved in an interaction.

The communication server may further be configured to retrieve relevant information on the parties involved in an interaction from the server database to be disseminated to the device and associated vehicle through the communication network. The device and associated vehicle may be configured to have an input interface and display to facilitate the communications between the parties and the communication server through the communication network. The associated vehicle may also be configured to receive a signal through the communication network to remotely turn off and disable the vehicle if needed. The ability to remotely control functions of a vehicle may be advantageous in order to prevent a driver from fleeing from the law enforcement officer and starting a possibly dangerous vehicle chase. It also may prevent drivers from evading law enforcement, and from causing possible harm to bystanders or property damage as a result of a vehicle chase.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic representation of an embodiment of the present invention.

FIG. 2 is a schematic representation of the device and its internal subparts in connection with the communication network, a vehicle that may be associated with the device, and a device.

FIG. 3 is a schematic representation of the communication server and its subparts in connection with the communication network and a server database.

FIG. 4 is a schematic representation of multiple devices or vehicles associated with the device in communication with each other through the communication network and communication server.

FIG. 5 is a schematic representation of a vehicle associated with the device and its subparts in connection with the communication network.

FIG. 6 is an illustration of a driver pulled over by a law enforcement officer where the two parties are using an embodiment of the present invention to communicate.

FIGS. 7-17 are flowchart illustrations of method aspects of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Additionally, in this detailed description, a person skilled in the art should not that the computer code terms, such as “instruction,” “information,” “code,” “computer code,” “software,” “algorithm,” and other terms are used, in general, to mean computer software and code used to operate a computation machine, or the computer software and code computation machines implement to exchange computer-readable information. The use and meanings and use of these terms is interchangeable.

Throughout the application, reference may be made to various computer hardware, including servers, storage, cloud storage, and the like. It is contemplated and included within the scope of the invention that the above-described system and its various components may be software executed on computer devices, including servers, personal computers, smartphone devices, and the like, each comprising a processor configured to execute commands received from software (such as microprocessors, field-programmable gate arrays, integrated circuits, and the like), a storage medium positioned in electrical communication with the processor and operable to store software and other digital information thereupon in one or both of transitory and non-transitory status (such as hard disk drives, solid state drives, flash drives, compact flash drives, SD drives, memory, and the like), and a network communication device comprising hardware operable to communicate across computer networks as are known in the art, including, but not limited to, wide area networks such as the Internet and mobile data networks, local area networks such as Ethernet and Wi-Fi networks, and personal area networks such as Bluetooth networks, as well as any other IEE 802.xx standard. Accordingly, it is contemplated and included within the scope of the invention that the computer hardware performing the above-described functions includes hardware necessary for such performance as is known in the art.

An embodiment of the invention, as shown and described by the various figures and accompanying text, provides a communication and mediation system and method according to an embodiment of the present invention is now described in detail. Throughout this disclosure, the present invention may be referred to as an interaction mediation system, mediation system, communication filter system, mediation accountability system, accountability system, an application system, a computer program product, a computer program, a product, a system, a device, and a method. Furthermore, the present invention may be referred to a relating to the implementation of an automated solution for regulating and mediating interactions between parties that may have a chance of friction or a confrontation between the parties during the interaction, and a solution for preventing and reducing requirements for face to face interactions between parties where the interactions have a chance of becoming confrontational. Further the parties to the mediation may be referred to as a driver, a citizen, a user, a civilian, a police officer, a law enforcement officer, the police, law enforcement, and/or a government agency. Those skilled in the art will appreciate that this terminology does not affect the scope of the invention. For instance, the present invention may just as easily relate to implementation of communication generally, remote controlling of vehicles, accountability systems, and mediation systems. The terminology referenced above is not meant to be limiting in any way and those skilled in the art will appreciate that other similar terms can be used and still be included in the scope of the present invention.

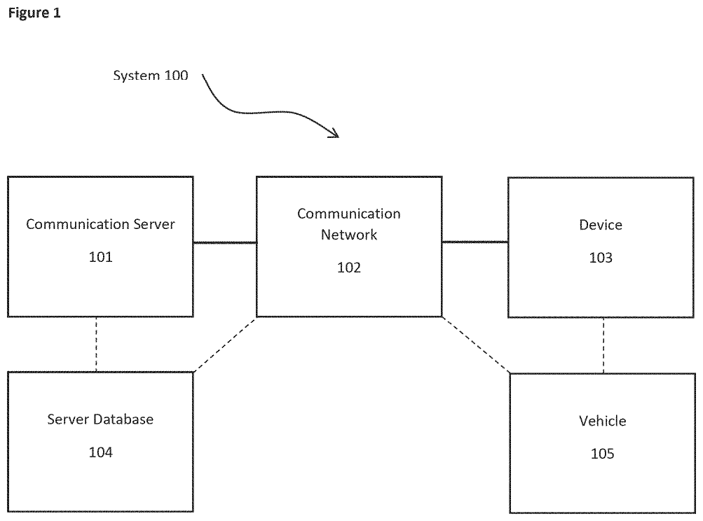

Referring now to FIGS. 1-3, a law enforcement communication system and device is now described in greater detail. In the following description, for purposes of explanation, numerous specific details are set forth to provide a thorough understanding of example embodiments. It will be evident, however, to one of ordinary skill in the art that the present invention may be practiced without these specific details and/or different combination of the details than are given here. Thus, specific embodiments are given for the purpose of simplified explanation and not limitation. Some of the illustrative aspects of the present invention may be advantageous in solving the problems herein described and other problems not discussed which are discoverable by a skilled artisan.

Embodiments of the present invention may be employed to facilitate the mediation of communication between two parties and may be used to obtain information about themselves or another party involved, and also may be used to remotely deactivate a vehicle with compatible functionality for such an action.

Throughout this specification, the term law enforcement may be used. Those skilled in the art will appreciate that law enforcement is mean to include law enforcement as an agency, a singular law enforcement officer, multiple law enforcement officers, or any type of authority that is empowered to have an interaction with a driver, a citizen or a civilian.

Embodiments of the present invention may be used to diffuse and prevent confrontations between two parties. Where the interacting parties may, for example, be between a law enforcement official and a driver pulled over by the official, or between a patient and his/her caretaker, or any other type of interacting parties, as may be understood by those skilled in the art. They may also be used to minimize the necessity of face to face contact between two parties in an interaction that may have a chance of becoming confrontational. The present invention may be particularly useful in situations where the driver is mentally or emotionally delayed. In cases such as this, there are often misunderstandings between the behavior of the driver and the communications of the officer. The present invention would advantageously decrease or eliminate such misunderstandings. Furthermore, the present invention may advantageously be used to act as an automated mediation tool by being a middleman for the parties' communications between one another.

Embodiments of the present invention may also be used to increase accountability of a party by requiring the party to input information about themselves, as detailed above, by various terminals that facilitate inputs and communications to the communication server 101 through the communication network 102 to be uploaded and stored in the communication server 101 and the server database 104. These terminals may, for example, without limitation, be personal computers, mobile enabled devices, internet enabled devices, tablet computers, and other terminals may be used as understood by those skilled in the art. The present invention may also increase accountability of the parties involved by creating a record of an event or of the interaction that may be viewed concurrently as the interaction takes place or after the fact by the user being allowed access to the record and connecting a device 103, vehicle 105 associated with the device, or other electronic devices (not shown) to the communication server 101 and server database 104 through the communication network 102 or other types of communication connections.

Referring initially to FIG. 1, a system 100 that may implement an automated method of mediating communications between two parties is provided. The system 100 may generally include a communication server 101, a communication network 102, and a number of connected devices 103. The connected devices 103 may, for example, be a computer, a tablet, a smart phone, or any other type of device that may be suitable to connect to the communications network 102 and that may be used to send and receive data and other communications. A vehicle 105 may be associated with the device. The vehicle 105 may, for example, be the vehicle of the law enforcement officer, the vehicle of a backup to the law enforcement officer, or the vehicle of a civilian that is being engaged by the law enforcement officer.

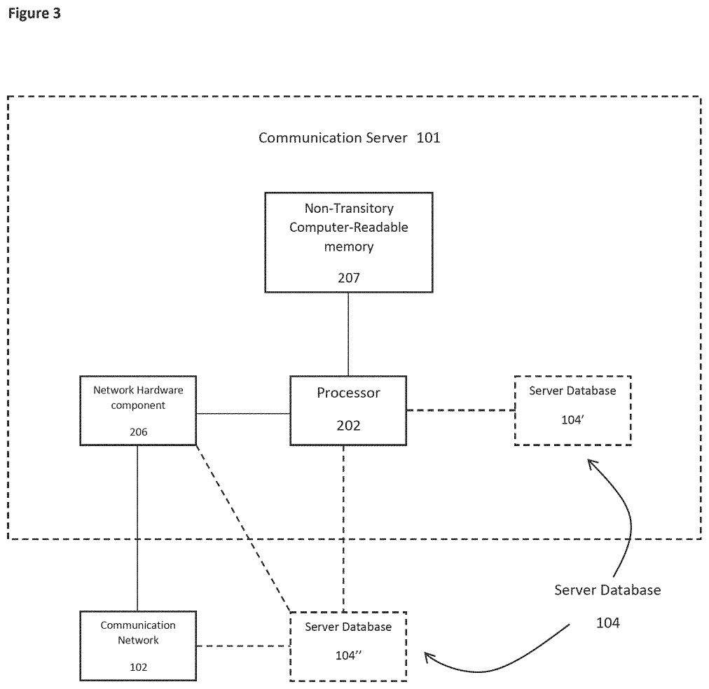

The communication server 101, as illustrated in FIG. 3, may include a network hardware component 206, a processor 202, a non-transitory computer-readable memory 207, and a server database 104. As perhaps best illustrated in FIGS. 1 & 2, the communication server 101 may be connected and configured in communication with a server database 104″ that is located external from the communication server 101, or a server database 104′ that is attached internally and configured in communication with the communication server 101. The communication server 101 may be connected to the server database 104 be through a direct connection, or through the communication network 102 or another type of connection, as may be understood by those skilled in the art. For example, and without limitation, the connection may be a landline, cable, ethernet, WiFi, cellular data, universal serial bus (USB), serial advanced technology attachment (SATA), or any other type of connection.

Continuing with reference to FIG. 3, the communication server 101 may execute software (not shown) which may be configured to facilitate and compute communications delivered to the communication server 101 from the connected devices and through processes and computations, the communication server may mediate communications received from the devices 103 and the vehicles 105 that may be associated with a device. This mediation may be done by the software filtering communications between the parties in order to ensure only allowable communications are able to pass between the connected devices 103, i.e., only allowable communications are able to be transmitted between the law enforcement officer and the driver. The software may also detect and filter undesirable communications. Undesirable communications may be subjective in nature, but, in general, undesirable communications may include, but not be limited to, those communications that could escalate emotions between the law enforcement officer and the driver such as, for example, aggressive words, foul language, threats, high tension in a voice, name calling, use of racial slurs, or any other type of communication that those skilled in the art may understand as being undesirable in nature.

The software may also be configured to send recommended responses and courses of action to the connected devices 103 or vehicles 105 that may be associated with a device 103 via the communication network 102. The software may also analyze the communications and prompt the user that sent the communication to make an informed decision whether to send, not send, change, and/or opt for a recommended communication provided by the communication server 101 once the communication server 101 has analyzed and computed the communication received from the device 103 or the vehicle 105 that may be associated with a device 103 through the communication network 102.

It is also contemplated that the software may prevent the transmission of a communication that is found to be undesirable. It is also contemplated that the software may be enabled with an override feature to allow a user to send a communication regardless of whether the software has found the communication to be undesirable. In a situation where an override is to be used, however, it is contemplated that a secondary authority must be contacted and/or consulted before an override can occur. For example, if a law enforcement officer desires to send a communication to the driver that the software has identified as undesirable, and the software has prevented the communication from being transmitted to the driver, the officer may not be able to override the software until a supervising officer has been consulted and/or the supervising officer has provided authority for the communication to be transmitted. Therefore, if the software is enabled with an override feature, it is contemplated that the override feature may also require authority to be transmitted from a party that is not involved in the transaction between the officer and the driver.

A non-transitory computer-readable memory 207 may be attached to the communication server 101 and configured to be in communication with the processor 202, as illustratively shown, for example, in FIG. 3. The non-transitory computer-readable memory 207 may be configured to store computer-readable instructions or code for access and use by the processor 202. The non-transitory computer-readable memory 207 can be provided by a plurality of types of computer-readable memories. For example, without limitation, random access memory (RAM), static random access memory (SRAM), dynamic random access memory (DRAM), read-only memory (ROM), erasable-programmable read-only memory (EPROM), electronically erasable programmable read-only memory (EEPROM), marked read-only memory (MROM).

The communication server 101 may be adapted to be in communication with a device 103 or a vehicle 105 that may be associated with a device through the communication network 102. The communication server 101 may also be connected to a vehicle 105 that may be associated with a device 105 which communicates with the communication server 101 either directly through the communication network 102 or indirectly through the communication network 102 and a device 103 connected to the vehicle 105 associated with that device 103. The communication server 101 may be configured to allow access thereto by any number of devices such as, for example, a mobile phone, a personal computer, a table, or a computer terminal. These other types of devices 103 that may be used to access the communication server 101 may also be configured to be in a direct connected communication to the communication server 101 or indirectly through the communication network 102.

As illustrated in FIGS. 1-5, the communication network 102 may be connected to the communication server 101, device 103, vehicle 105 that may be associated with a device, and server database (not shown) in a variety of ways. For example, without limitation, the connection may be through Wi-Fi, cellular data, universal serial bus (USB), fiber optic cable, cable, DSL, satellite, or landline. The connections to the communication server 101 with the communication network 102 may generally be connected to the communication server's 101 network hardware component 206. However, those skilled in the art will appreciate that there are a number of different connection points the communication network 102 can connect with the communication server 101 while still accomplishing all the goals, features, and advantages according to the present invention. The communication network 102 may be used to facilitate communications and exchanges of computer readable information, code, and instructions between the device 103, communication server 101, a vehicle 105 that may be associated with a device, a multiple other devices 103 or vehicles 105 that may be associated with a device, and a server database 104.

Referring now specifically to FIG. 3, the processor 202 of the communication server 101 may be configured to be in communication with the network hardware component 206, and the non-transitory computer-readable memory 207. The processor 202 may be used as the component that processes the commands, instructions, and signals to be received, transmitted, and computed by the communication server 101. There are a number of different types of processors that may be used as the processor 202 in the communication server 101. Such processors that may be used for example, without limitation, a microprocessor, microcontroller, embedded processor, or digital signal processor. Those skilled in the art will appreciate that a plurality of different processors may be used as the processor 202 for the communication server 101 while still accomplishing the goals, features, and advantages of the present invention. The processor 202 may be configured to compute all signals received and transmitted through the network hardware component 206.

Referring now additionally to FIGS. 1 and 3, the server database 104 may be configured to receive, store, and transmit a plurality of computer readable information. A server database 104′ may be configured to be connected directly to the communication server 101. In one embodiment of the invention, the server database 104′ may be a component that is located within the communication server 101, e.g., an internal server database. In another embodiment of the present invention, the server database may be a server database 104″ that may be an external component or separate server located outside or separately from the communication server 101 and that may be connected to the communication server 101 via the communication network 102, the network hardware component 206, or the processor 202. The server database 104′, 104″ may be configured to receive information to be stored therein through any channel of exchange of computer-readable information. For example, but not limited to, the communication network 102, a universal serial bus (USB), ethernet, cable, DSL, serial advance technology attachment (SATA), wi-fi, satellite, and Bluetooth. The same channels of computer-readable information may be used to also transmit information from the server database 104.

Now referring specifically to FIG. 3, the server database 104 may be configured to receive, store, and transmit computer readable instructions, code, and information. The server database (not shown) may comprise of, but is not limited to, a hard disk drive (HDD), solid-state drive (SSD), non-volatile memory express solid-state drive (NVMe SSD), or magnetic tape data storage. The instructions, code, and information may include the software to run the present invention, and information desired to be stored to mediate interactions between two parties, and to facilitate accountability and transparency between the parties. Such information may include, but is not limited to, driver's license numbers, insurance information, vehicle identification numbers (VIN), vehicle license plate numbers, vehicle registration information, information on whether a party has an outstanding warrant, whether a party has a criminal history and what the criminal history is, an officer's badge number, and officer's name, whether a party has a gun license, whether a party has past traffic infractions, and personal information about a party such as their name, address, occupation, and zip code. Other information may also be exchanged between the two parties, as may be understood by those skilled in the art.

The software may be configured to receive an authorized signal from a connected device 103 in order to then pass the signal to a vehicle 105 that may or may not be associated with a device to disable the vehicle 105. The signal may first be authenticated by the software to ensure only authorized signals will have the capability to disable the vehicles 105 or control other functions of the vehicles 105. For example, without limitation, the software may read a signal received from a device 103 connected through a communication network that was sent by law enforcement or another third party in order to disable a vehicle 105 that has such functionality to receive and execute such a signal. Those skilled in the art will appreciate that any party can be given access to send these signals, and that the signals can be varied to control a plurality of functions on a vehicle capable to receive and execute the instruction received through the signal as explained further below.

The software may also be configured to detect when a heated confrontation may be imminent within the near future between two parties and output a signal to call for a supervisor, someone of equal status and responsibility, or a backup law enforcement officer to arrive at the scene of the interaction in order to supervise and mediate the situation to ensure neither party engages in any action which may considered confrontational or illegal. Similarly, the software may also be configured to contact someone associated with the driver, such as a parent, guardian, loved one, friend, etc., that may be needed to assist in de-escalating a situation. Further for example, in a scenario where the driver is someone that is a minor, and the parent and/or guardian of the driver uses the system in order to ensure that the user is safe and accountable, the system may be configured to automatically contact the parent and/or guardian to ensure that they are made aware that the system has been activated and that the user is in a situation where they are being pulled over by a law enforcement officer.

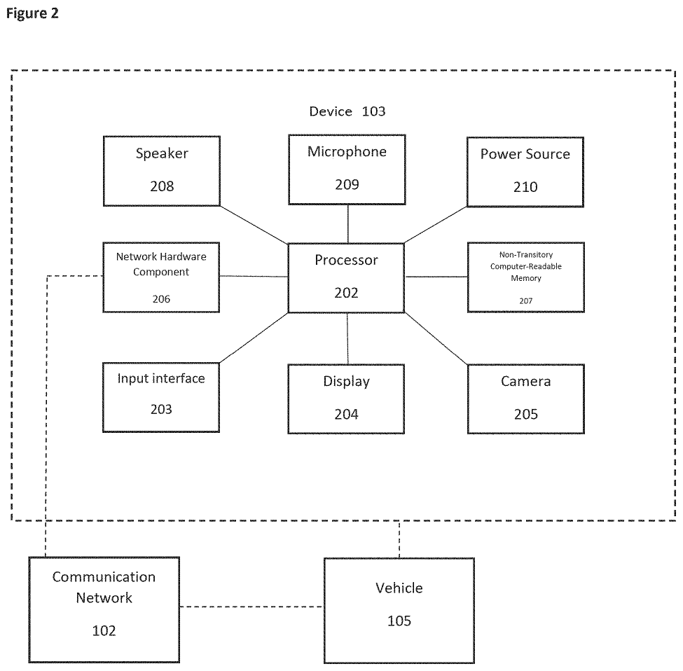

Referring now to FIGS. 2 & 5, an embodiment of the present invention may illustratively include a device 103 and a vehicle 105 that may be associated with the device 105 that may each be configured to be in communication and in connection with the communication network 102. The device 103 may include a processor 202 to process computer code and instructions. The device 103 may further include a network hardware component 206 to facilitate sending and receiving communications to and from the device 103. The device 103 may also include an input interface 203 that may be connected to the processor 202 so that a user of the device 103 can interact with the device. The device 103 may still further include a display 204 that may be connected and in communication with the input interface 203 and the processor 202 so that a user of the device can observe the operations and inputs and outputs of the device 103 or vehicle 105 that may be associated with the device 105. A camera 205 may be included so that a user can receive and transmit photos or videos associated with the incident, i.e., associated with the traffic stop or the interaction between the law enforcement officer and the driver. Non-transitory computer readable memory 207 may also be included to facilitate storage of computer instructions. A speaker 208 may be provided and configured to emit sound from the device 103 or vehicle 105 associated with the device 103. The device 103 may also include a microphone 209 configured to register audio sounds heard by the speaker, as well as a power source 210 to deliver electric power to the device 103 or vehicle 105 that may be associated with a device 103 and to the electronic sub-components associated with the components described above.

Continuing to reference FIGS. 2 & 5, the processor 202 may be attached to the device 103 or the vehicle 105 that may be associated with a device and may be placed in connection and in communication with the network hardware component 206, the input interface 203, the display 204, the camera 205, the non-transitory computer-readable memory 207, the microphone 209, and the power source 210. The processor 202 may be used as the component that processes the commands, instructions, and signals to be received, transmitted, and computed by the device 103. There are a number of different types of processors that may be used as the processor 202 in the device 103. Such processors that may be used for example, without limitation, include a microprocessor, a microcontroller, an embedded processor, or a digital signal processor. Those skilled in the art will appreciate that a plurality of different processors may be used as the processor 202 for the device 103 or the vehicle 105 associated with the device while still accomplishing all the goals, features, and advantages of the present invention.

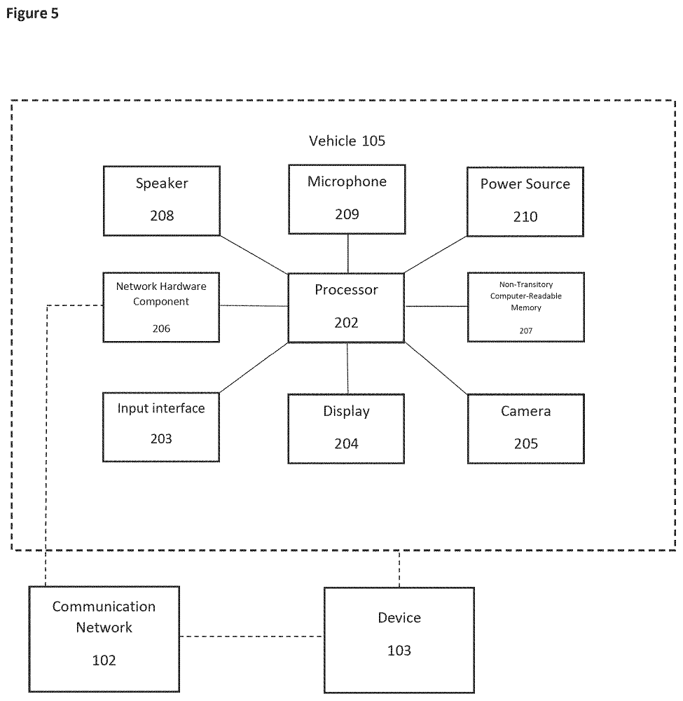

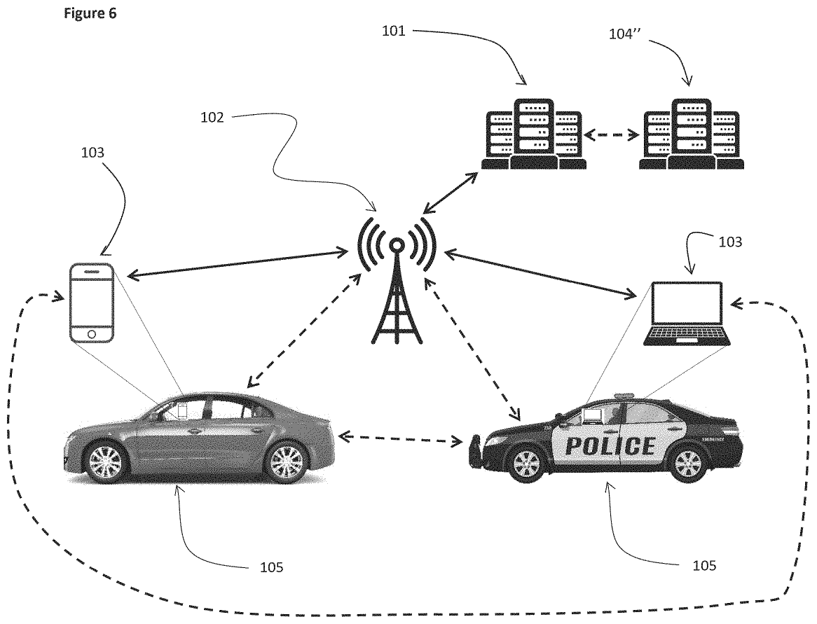

Continuing to reference FIGS. 2 and 5, the display 204 may be configured to also register user inputs by operating in conjunction and being in connection and communication with the input interface 203. For example, without limitation, a touch screen display that may be either a capacitive or a resistive touch screen display. The display 204 may be comprised of any of the following, without limitation, an LED display, LCD display, ELD display, OLED display, AMOLED display, Plasma display, or QLED display.

Now referencing FIGS. 1-5, The communication network 102 may be connected and configured to be in connection with the network hardware components 206 and a plurality of other electronic devices (not shown) to facilitate communication with the communication server 101, devices 103, vehicles 105 that may be associated with a devices 103, and the plurality of other electronic devices (not shown). The communication network 102 may transfer, receive, and facilitate computer signals through and by any of the following without limitation: Wi-Fi, Bluetooth, Cellular data, Wi-Fi Ad Hoc, Dial-up, broadband, DSL, cable, satellite, and ISDN. Those skilled in the art will appreciate that a plurality of different computer communication connection types can be used with the communication network 102 and accomplish all the present invention's goals, features and advantages.

Now referencing FIGS. 2 and 5, the network hardware component 206 may be configured to be in communication and placed in connection with the processor 202 and in connection with the power source 210. The network hardware component 206 may be configured to receive and transmit a variety of types of computer generated and computer readable signals. For example, without limitation, ethernet, Wi-Fi, cable, fiber optic, DSL, Bluetooth, cellular data, Wi-Fi Ad Hoc, satellite, landline, universal serial bus (USB), and serial advanced technology attachment (SATA). Those skilled in the art will appreciate that a plurality of signal types can be used while still accomplishing all the goals, features, and advantages of the present invention.

Continuing to reference FIGS. 2 and 5, the non-transitory computer-readable memory 207 may be attached to the device 103 and in communication to the processor 202. The non-transitory computer-readable memory 207 may be configured to store computer-readable instructions or code for access and use by the processor 202. The non-transitory computer-readable memory 207 can be a plurality of types of computer-readable memories. For example, without limitation, random access memory (RAM), static random access memory (SRAM), dynamic random access memory (DRAM), read-only memory (ROM), erasable-programmable read-only memory (EPROM), electronically erasable programmable read-only memory (EEPROM), marked read-only memory (MROM). The non-transitory computer-readable memory 207 may also comprise of other memory components. For example, without limitation, a hard disk drive (HDD), solid-state drive (SSD), non-volatile memory express solid-state drive (NVMe SSD), flash memory, or magnetic tape data storage.

Continuing to reference FIGS. 2 and 5, the speaker 208 may be attached to the device 103 and/or a vehicle 105 that may be associated with the device 103. The speaker 208 may be connected and configured to be in communication with the processor 202 of the device 103 or the vehicle 105 that may be associated with the device 103. The speaker 208 may be used to emit audible sounds from signals sent to it. Those skilled in the art will note that the speaker 208 can comprise of any component capable of converting computer readable or analog signals into kinetic sound outputs by functioning as an electrostatic transducer.

Continuing to reference FIGS. 2 and 5, the microphone 209 may be attached to the device 103 and/or the vehicle 105 that may be associated with a device 103. The microphone 209 may be connected to be in communication with the processor 202. The microphone 209 may also be configured to be in communication and in connection with other electronic devices (not shown) as laid out above or other electronic components of an embodiment of the present invention as understood by those skilled in the art. The microphone 209 may be used to register audible sounds and translate them into computer readable instructions to then be sent and computed by the processor 202. The computer recorded sounds from the microphone 209 may be recorded, send a live playback of the audio, or be used for voice recognition. The microphone 209 may comprise of a plurality of compatible devices capable of picking up and translating audible sounds into computer readable language or analog signals. For example, without limitation, the microphone 209 may comprise of a condenser microphone, an electret microphone, a dynamic microphone, a ribbon microphone, a carbon microphone, a piezoelectric microphone, a fiber-optic microphone, a laser microphone, a liquid microphone, a microelectromechanical systems microphone, or other component that can be used as a microphone as understood by those skilled in the art.

Continuing to reference FIGS. 2 and 5, the camera 205 may be attached to the device 103, or it may be attached to the vehicle 105 associated with the device. The camera 205 may also be a stand-alone member that is not attached to the device 103 or vehicle 105 that may be associated with the device 103, but the camera 205 may also be configured to be in communication with the device 103 or vehicle 105. The camera may be connected and configured to be in communication with the processor 202, or it may be connected can configured to be in connection with a vehicle 105 that may be associated with a device 103. The camera 205 may be used, without limitation, to take photos, record video, send live feeds of video, face recognition, or text recognition. Those skilled in the rat not note that a plurality of components may be used as the camera for an embodiment of the prevent invention. For example, without limitation, DSLR, mirrorless, bridge, compact digital, film, action, 360, and digital cameras.

Continuing to reference FIGS. 2 and 5, the input interface 203 may be attached and configured to be in communication with the device 103 or a vehicle 105 that may be associated with a device 103. The input interface may also be unconnected to either the device 103 or the vehicle 105 such that it is a free member to be handled and moved around, or it may be attached to another object. For example, and without limitation, a wireless keyboard in communication with the device 103 or the vehicle 105. The input interface may be configured to register a number of different inputs entered by a user. For example, and without limitation, text inputs, button inputs, touch-screen inputs, capacitive inputs, resistive inputs, turn nob inputs, dial turn inputs, global positioning satellite inputs, accelerometer inputs, facial recognition inputs, or voice inputs. A plurality of different devices may be used as the input interface 203. For example, and without limitation, the input interface 203 may comprise of a member that resembles a touch screen, keypad, or keyboard. Those skilled in the art will recognize and appreciate that a plurality of different input devices may be used for the input interface 203 of the device 103 or the vehicle 105 while still accomplishing the goals, features, and advantages of an embodiment of the present invention.

The power source 210 may illustratively be attached to the device 103 and may be in connection with the processor 202, the microphone 209, the display 204, the camera 205, the non-transitory computer-readable memory 207, the input interface 203, the network hardware component 206, and the speaker 208. The power source 210 may be used to supply electrical power to the components connected to it. The power source 210 may comprise and any power source that can supply electrical power. For example, but not limited to, lithium battery, nickel oxyhydroxide battery, solid-state battery, alternating current (AC) wall outlet, solar power array, electric generator, an alternator, or an automotive battery. When the power source 210 obtains its supply of power from an alternating current (AC) power supply, the power source may be configured to have the functionality to convert the AC power supplied to it into direct current (DC) electrical power.

Referring now specifically to FIG. 5, a vehicle 105 that may be associated with a device 103 may also include a processor 202 to process computer code and instructions. The vehicle 105 may further include a network hardware component 206 to facilitate sending and receiving communications to and from the vehicle 105. The vehicle may still further include an input interface 203 that may be connected to the processor 202 so that a user of the vehicle 105 can interact and enter inputs with the vehicle 105. The vehicle may also include a display 204 that may be connected to the input interface 203 and the processor 202 so that a user of the vehicle 105 can observe the operations and inputs and outputs of the vehicle 105. The vehicle may also include a camera 205 so that a user can send or record photos or videos. Non-transitory computer readable memory 207 may also be included to facilitate storage of computer instructions. The vehicle may further include a speaker 208 configured to emit audible sound, and a microphone 209 configured to hear and register audio sounds heard by the microphone 209. A power source 210 may be provided to deliver power to the electronic sub-components connected to the vehicle 105 that facilitate running an embodiment of the present invention. The listed sub-components of the vehicle 105 may have similar or the same connections, functionality, and composition as laid out for the sub-components for the device 103 laid out above, as illustrated in FIG. 2.

A vehicle 105 that is associated with a device may be configured to be in communication with a device 103 through a plurality of connections. For example, and without limitation, the vehicle 105 associated with a device 103 may be connected via Bluetooth, Wi-Fi, and Wi-Fi ad hoc. Those skilled in the art will note and appreciate that there are a plurality of different connections that may be used to facilitate communication between the vehicle 105 and a device 103 that is associated with that vehicle while still accomplishing the features, goals, and advantages of an embodiment of the present invention.

The device 103 or vehicle 105 used by a driver may include different components and different features than what may be available to an officer on the officer's device 103 or vehicle 105. Furthermore, a device 103 used by a user may have an interface configured to be in communication with a vehicle 105 associated with the device 103. This interface may be used to pair the vehicle 105 to be associated with the device 103 being used by the user so that both may be associated with one another and with the identity of the user. The interface may also grant the user additional functionality to control the vehicle 103 with the interface of the device. For example, but not meant to be a limitation, locating the vehicle 105, turning the vehicle 105 on or off, disabling the vehicle, or any other number of functions that may be possible by interfacing with the various systems of the vehicle.

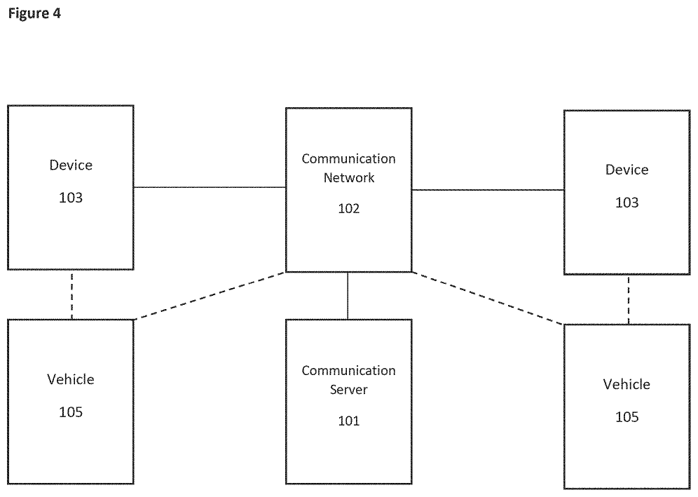

Now referencing FIG. 4, the vehicle 105 may be configured so that it does not rely on a connection to a device 103 in order to be connected to the communication network 102 or the communication server 101. The vehicle 105 may be configured such that it can directly communicate with another vehicle 105 associated with a device 103, a device 103, a vehicle 105, or other electronic device (not shown) through the communication network 102 and the communication server 101, or by other types of connections and configured communications. For example, and without limitation, an officer's patrol vehicle may be configured such that it can facilitate the features, goals, and advantages of the embodiments of the present invention without requiring a device 103 to be used by the officer by having the officer's vehicle configured to be directly connected to the communication network 102, device 103, vehicle 105 associated with the device, or other electronic device (not shown) through a plurality of types of communication. For example, without limitation, the communication from the officer's vehicle to a device 103, a vehicle 105 associated with a device 103, a vehicle 105, or other electronic device (not shown), may be through Wi-Fi, ethernet, cable, DSL, satellite, Wi-Fi ad hoc, Bluetooth, USB, SATA connections or other types of connection and communication as understood by those skilled in the art. The communication from the officer's vehicle 105 to the vehicle 105 used by a driver may instead indirectly first travel through the communication server 101 before being forwarded to the desired recipient's vehicle 105. This communication sent by the officer may also have to indirectly travel through the device 103 that is associated with the vehicle 105 of the desired recipient, which is then forwarded to the vehicle 105 from that device 103.

Embodiments of the present invention may run software (not shown) that is configured with instructions to facilitate, enable, and operate a number of computer functions. These computer functions may include, but not be limited to, data retrieval, data sorting, data storage, data analyzing, machine learning, and reaction responses.

Users that may have access to the records may be limited by certain parameters. Such as, without limitation, access may only be to insurance companies, courts of law, law enforcement, family of a party(ies) involved in the recording, a person who was in the recording, the general public once an amount of time has passed since the recording's date, or other limitation as understood by those skilled in the art.

Embodiments of the present invention may also be configured to activate the mediation applied by the communication server 101 once a driver is pulled over either automatically by a device 103, vehicle 105 that may be associated with a device 103, or by the communication server 101 detecting that a pullover of the driver has taken place, or other triggering event. For example, without limitation, when a user's decibel level of their voice reaches a certain threshold, or when a user's heart rate level has passed a certain threshold when a device 103 or vehicle 105 associated with the device 103 or vehicle 105 is connected and configured to be in communication with a compatible heart rate monitoring component (not shown) that detects the user's heartrate. The automatic or manual triggering of an event activating an embodiment of the present invention may also be limited by detecting the proximity of multiple users' devices 103 and/or vehicles 105 compared to each other by using a global positioning satellite (GPS) system (not shown), or other instrumentation or methods of detecting and monitoring position as understood by those skilled in the art.

Embodiments of the present invention may be activated to begin communication and/or mediation process between parties by manual user input into the input interface 203 of a device 102 or a vehicle 105 by either of the parties, or its activation may be limited to a preset selected number of parties or party. For example, without limitation, activation of the present invention may be limited to only law enforcement personnel. Those skilled in the art with note and appreciate that there are a plurality of parameters and methods of activation that can be implemented in an embodiment of the present invention that may be used to initiate the communication and/or mediation processes of the present invention.

Once an embodiment of the present invention has been activated, it may inform users of information either automatically upon a detected triggering event, by manual request by a user, or by request of another party by entering in an input into the input interface 203 of the user's respective device 103 or vehicle 105 that may be associated with the device 103. The input may be sent to the communication server 101 through the communication network 102. The required inputs may be for example, a single input such as a button or swipe on a touch screen interface used as the input interface 203, voice activation through the microphone 209, predetermined required information to be entered into the input interface 203 such as the user's personal information and location, a password previously set up by the user, or other required input information as understood by those skilled in the art, or the passage of a predetermined and preset amount of time after a request by one party has been made and the other party has not entered any inputs into his or her input interface 203. The information that is sent to a party may be via the communication network 102 that is stored in the communication server 101 and/or server database 104.

The information sent to either party after an embodiment of the present invention has been activated may, for example, be any of the following information: relevant advice; why the user is being pulled over; why the user is being stopped; why the user is being detained; why the user is being confronted by the other party; or other relevant information as understood by those skilled in the art for a traffic stop. The relevant advice may be relevant legal information such as legal rights and relevant laws applicable to the given interaction, the personal information about the other party(ies) in the interaction, the courses of action available for the user to take, the likely consequences for taking certain courses of action, recommended courses of action for the user to take, or other relevant legal advice as understood by those skilled in the art for the given interaction of the parties. The information disseminated to certain parties may also be tailored depending on that certain party's status. For example, without limitation, an officer's status as a law enforcement official may be given certain information from the communication server that is otherwise not sent to other parties. Also for example, and without limitation, whether the other party the officer has pulled over is subject to open warrants for their arrest and/or detainment, a criminal background, arrest history, or other relevant information for the officer to know about the party pulled over as understood by those skilled in the art.

After an embodiment of the present invention has been activated and relevant information to each user has been disseminated to each respective party's device 103 or vehicle 105 that may be associated with his or her device 103, an embodiment of the present invention may be configured to facilitate mediated communication between the parties. The communication may be either via messaging with text, video recordings, live video feeds, sending photos or pictures, voice recordings, like voice chat, or other types of communication which pass through the communication server 101 via the communication network 102 before being forwarded to the desired party to receive the communication via the communication network 102. These modes of communication may be facilitated by the microphone 209, speaker 208, input interface 203, and the camera 205 located on the device 103 or the vehicle 105 associated with the device. Those skilled in the art will appreciate that there are a plurality of types of communication which can be held between the parties involved in an interaction that may be implemented by an embodiment of the present invention while still accomplishing all the features, goals, and advantages of the present invention.

Software in the communication server 101 and the system 100 may detect when the communication has become confrontational, or has a probability of becoming confrontational, and the communication server 101 may call a supervisor of either of the parties to arrive to the scene of the interaction via the communication network 102 to the desired electronic device (not shown) that is able to receive such communication to contact the desired supervisor. The software analyze the communication traffic of each user that travels through the communication server 101 via the communication network 102, and implementing a number of confrontation detection parameters, such as the time in between responses by a party, the words used in each response, the types of photos sent in each response, the lack of responses, and the decibel level of speech or sounds sent or received in audio or video communications, or other confrontation detection parameters as understood by those skilled in the art. The software in the communication server 101 may also read and analyze communications sent or received by either party and send the relevant party a recommended response or recommended course of action in response to the communication sent or received in order to encourage a nonconfrontational interaction through the communication network 102.

The software in the communication server may also be configured to connect to other servers or communication networks to facilitate additional functionality, for example, without limitation, for officers to securely upload a police report of the event, or for a driver to file an insurance claim.

The software implemented on an embodiment of the present invention may allow for additional functionality for authorized parties to unilaterally initiate communication with another party's vehicle or for a party to unilaterally control a plurality of functions of another party's vehicle. For example, without limitation, an officer may be authorized and may be given the ability to communicate to another party's device 103 or vehicle 105 that may be associated with a device 103 using the officer's device 103 or vehicle 105 to unilaterally: initiate vocal communication with the other user through that party's speakers 208; turn off the party's car; or disable certain functions of the party's vehicle 105 such as the ability to drive above a certain speed limit or the ability for the party to turn his or her vehicle 105 on. An authorized user may also be given the ability to track a user's location by use of a GPS tracking system (not shown), which will be displayed on the authorized user's display 204 on his/her device 103 or vehicle 105 associated with the device.

As mentioned above, these functions may be available to an authorized user through a vehicle that has the hardware installed (not shown) to enable these functions to be available to him/her. The unilateral control of another party's vehicle may be configured to be allowed only when certain parameters that are set and are found by the communication server 101. The certain parameters set may be, without limitation, when communication through an embodiment of the present invention has been initiated between an officer and a driver that is pulled over, and the communication server 101 detects that the driver has began to drive away before the communication between the parties has been completed. The communication server 101 may detect this movement by receiving information transmitted from either the driver's device 103, vehicle 105, or vehicle 105 that is associated with a device 103 that the communications between the parties has not yet ended and the driver has begun or is attempting to drive away. The device 103, vehicle 105 associated with the device, or vehicle 105 not associated with a device may be able to detect this movement of location by use of a GPS tracking system (not shown) and transmit this data to the communication server 101 via the communication network 102. The GPS location of the driver changing before the communication between the parties has ended may activate the ability for the officer to control the functions of the driver's vehicle 105.

The functionality of disabling the driver's vehicle may also be automatically done by the driver's device 103 or vehicle 105 that may be associated with the driver's device 103 when it is detected that the driver has begun or is about to drive away from the officer before the communications with the officer during a stop have been concluded. This detection may be done by the driver's device 103 or vehicle 105 monitoring the location of the driver's device 103 or vehicle 105 with a GPS system (not shown). The detection may also be done by the driver's vehicle 105 detecting when the driver presses down on the gas petal in order to have the vehicle 105 accelerate, or when the driver operates the vehicle 105 to change gears from park or neutral to then be in drive or reverse.

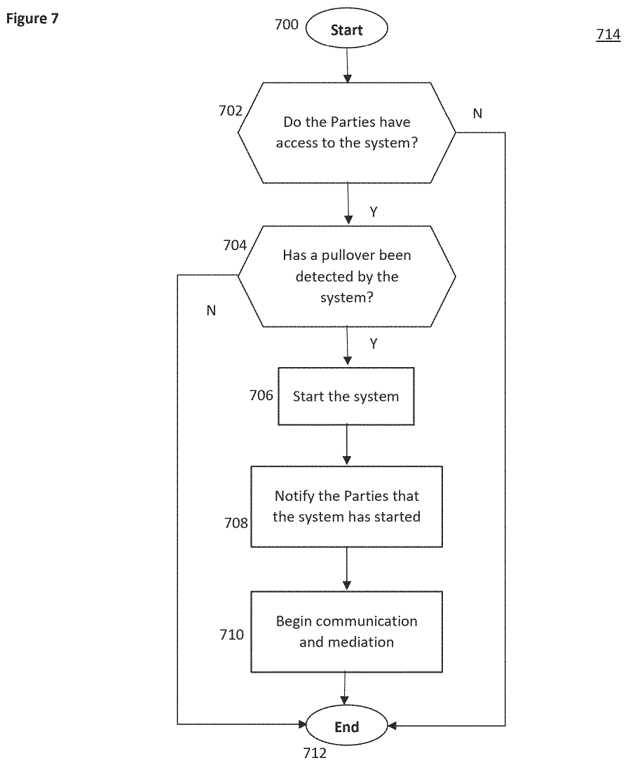

Referring now to FIG. 7, additional details regarding automatic initiation of the system 100 are now discussed. More specifically, the steps of automatic initiation of system 100 may comprise the steps illustrated in method 714 depicted in FIG. 7. Starting at Block 700 and continuing to Block 702, the system 100 may determine whether the parties involved have access to the system 100. This may be done, for example, and without limitation by the system 100 using the communication network 102 to detect if the parties have the system 100 connected to or running on the parties' device(s) 103 or vehicle(s) 105. If the parties do not have access, then the system 100 may end the process at Block 712. If, however, the parties do have access, then the system 100 may continue to Block 704 to determine whether the system 100 has detected if a pullover has taken place. This may be done by the system 100, for example, and without limitation, by tracking the parties' locations to determine whether the parties have stopped within the same small area near each other, or may be performed by a signal or other information received from the law enforcement officer's vehicle 105 indicated that the emergency lights and/or siren has been activated. If it is determined that a pullover has not taken place, then the method 714 may end at Block 712. If, however, it is determined that a pullover has taken place then the system 100 may initiate at Block 706, and the parties may be notified at Block 708 that the system 100 has been activated. Then communication and mediation through the system 100 may then begin at Block 710. Thereafter, method 714 may end at Block 712.

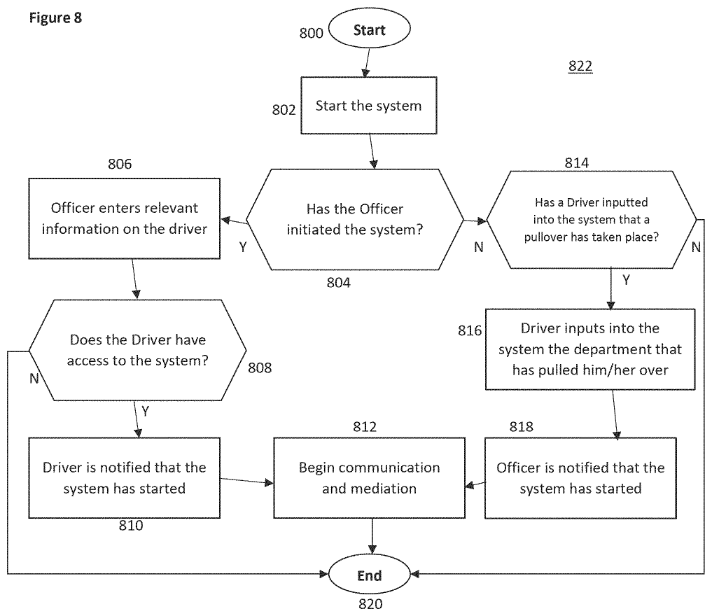

Now referring to FIG. 8, additional details regarding manual initiation of the system 100 are now discussed. More specifically, the steps of manual initiation of the system 100 may comprise the steps of method 822 illustrated in FIG. 8. From the start (Block 800), the system 100 is initiated at Block 802. The system 100 may be started, for example, and without limitation, by any of the parties involved entering an input in their respective device 103 or vehicle 105. It then may be determined at Block 804 if it was the officer that pulled over the driver who initiated the system 100. If it is determined that it was the officer who initiated the system 100, then at Block 806 the officer may enter in relevant information about the driver into the system 100. For example, but not limited to, the driver's license plate number, the make and model of the vehicle, or any other type of information that may be relevant to the driver. It then may be determined by the system 100 at Block 808 whether the relevant information by the officer is linked to any user of the system that could be identified as the driver. If the system 100 does not find any user of the system 100 linked to the information inputted by the officer, then the method 822 may end at Block 820. If, however, at Block 808, the system 100 does find a user linked to the information entered by the officer, then at Block 810 the driver may be notified that the officer has initiated the system 100. Thereafter the communication and mediation of the system 100 may begin at Block 812 and the method 822 of manual initiation of the system 100 may end at Block 820.

Referring back to Block 804, if it is determined that the officer did not initiate the system, it then may be determined at Block 814 whether the driver has made inputs into the system 100 to signal that a pullover has taken place. For example, without limitation, the inputs by the driver may be entering into their device 103 or vehicle 105 that a pullover has taken place by pressing a button or input signaling a pullover has taken place. If it is determined from the driver's inputs, or lack of inputs, that a pullover has not taken place then the method 822 of manual initiation of the system 100 may end at Block 820. If the driver has inputted that the pullover has taken place, then at Block 816 the driver may input into the system 100, without limitation, what department, officer, or squad car has pulled the driver over so that the system 100 may determine which officer to initiate communication and mediation with. Then at Block 818 the officer found by the system to be involved in the pullover may be notified that the system 100 has been initiated. Lastly, at Block 812 the system 100 may begin communication and mediation between the parties involved and may end the method 822 for manual initiation of the system 100 at Block 820.

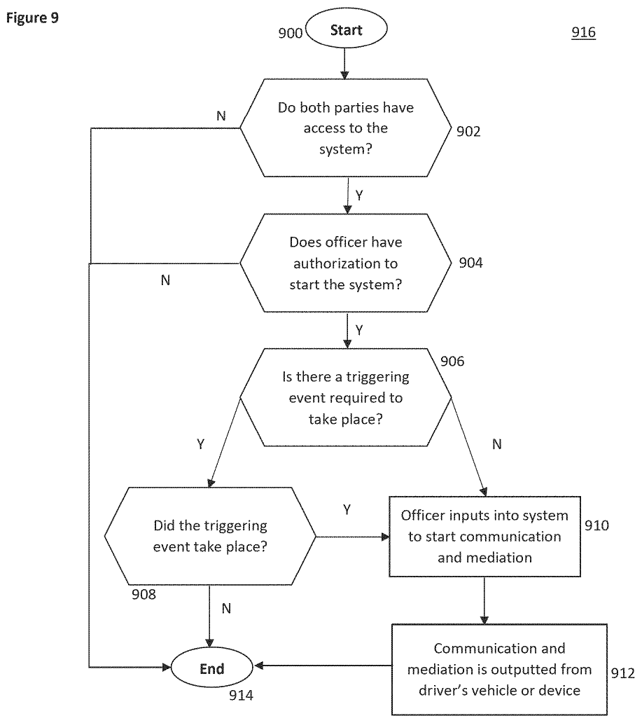

Referring now to FIG. 9, additional details regarding a method 916 of initiating unilateral communication with a driver's device 103 or vehicle 105 via the system 100 is now discussed. More specifically, from the start (Block 900) it may be first determined at Block 902 whether the parties (i.e. an officer and a driver) all have access to the system 100. This determination may be done, without limitation, by the system 100 detecting through the communication network 102 that the parties have the system running or installed on their respective device(s) 103 or vehicle(s) 105. If not, then method 916 may end at Block 914. If the parties do have access to the system 100 it may then be determined at Block 904 whether the officer has authorization to unilaterally initiate the system 100 with the desired driver's device 103 or vehicle 105. This may be done, for example, without limitation, by the system 100 having access to a reference list of individuals who have access to this feature. If it is determined that the officer does not have authorization, then the method 916 may end at Block 914. However, if it is determined at Block 904 that the officer does have authorization or does not require authorization, then at Block 906 it may be determined whether there must be a triggering event required to take place in order for the officer to unilaterally initiate communication with the driver via the system 100. For example, and without limitation, a triggering event may be the system 100 detecting that the officer has been attempting to pull the driver over without success. This may be accomplished by the system 100 detecting that the officer and the driver have been driving near each other for an extended period of time while the system detected that the officer has had the emergency lights and/or sirens of the vehicle on for that extended period of time. If it is determined that a triggering event is required for the officer to initiated unilateral communication, then it may be determined at Block 908 whether a triggering event allowing the unilateral communication has taken place. If not, the method may end at Block 914. If it is determined that a triggering event has taken place, then at Block 901 the officer may input into the system 100 to unilaterally start communication and mediation with the driver. Thereafter, at Block 912 the inputted communications by the officer may be outputted to the driver's device 103 or vehicle 105. For example, and without limitation, having the officer send audible voice communication to be outputted to the driver's device 103 or vehicle 105. Then, the method 916 may end at Block 914.

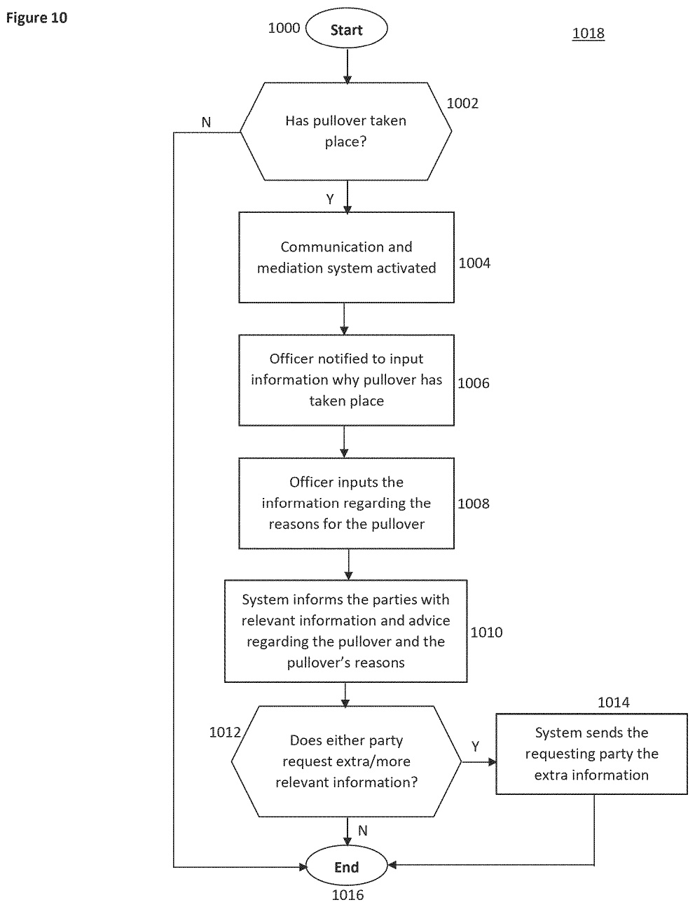

Now referring to FIG. 10, a method 1018 for disseminating relevant information for a pullover is now described in greater detail. More specifically, FIG. 10 shows the steps of method 1018 for parties to receive and request more relevant information from the system in the event of a pullover. From the start (Block 1000), it is determined by the system 100 whether a pullover has taken place at Block 1002. This may be done by the system 100, for example, and without limitation, by tracking the parties' locations to determine whether the parties have stopped within the same small area near each other. If it is determined by the system 100 that no pullover has taken place, the method 1018 may end at Block 1016. However, if it is determined that a puller has taken place, the communication and mediation of the system 100 may be activated at Block 1004. Then at Block 1006 the officer may be prompted and notified to enter in why a pullover has taken place into the system 100. The officer then may input this information into the system at block 1008. Then at Block 1010 the system 100 may disseminate the relevant information pertaining to the pullover to the parties involved in the stop along with the information the officer inputted as the reason(s) for the pullover. It may then be determined at Block 1012 if either party requests to receive any extra information that may be relevant to the pullover. This may be done, for example, without limitation, by a party entering in inputs into their respective device 103 or vehicle 105 that they want to receive more information from the system 100 that may be relevant for the pullover at hand. If it is determined that neither party requests further relevant information, then the method 1018 may end at Block 1016. Otherwise, if it is determined that a party requests further relevant information, then the system 100 may send the extra requested relevant information to the parties at Block 1014 and then the method 1018 for disseminating relevant information may end at Block 1016.

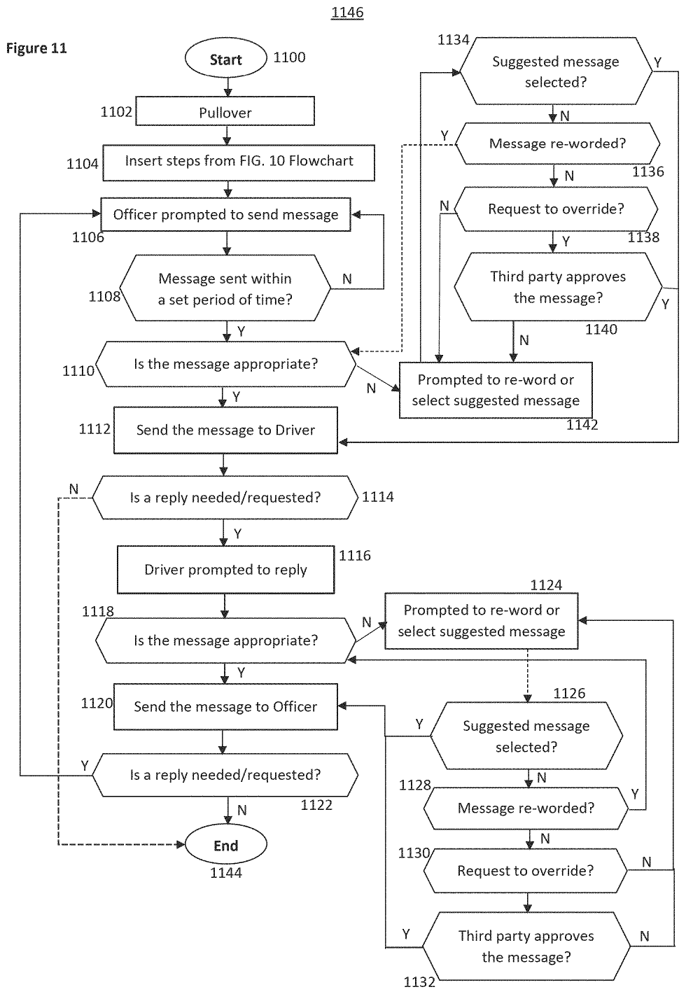

Referring now to FIG. 11, a method 1146 for communication and mediation via the system 100 is now described in greater detail. From the start (Block 1100) a pullover may take place at Block 1102 and then relevant information may be disseminated at Block 1104 by the method 1018 illustrated in FIG. 11. At Block 1106 the officer may then be prompted to send the first message to the driver(s). It may then be determined in Block 1108 if the officer has sent the first message within a set period of time. If it is determined that that officer has not sent a message within the set period of time, then at Block 1106 the officer may again be prompted to send the first message. The loop of notification may continue between Block 1106 and Block 1108 until the officer sends a message.

When it is determined at Block 1108 that the officer has sent a communication, it may then be determined at Block 1110 whether the communication is appropriate. For example, without limitation, appropriate communications may be those that are deemed least likely and at the lowest risk of starting or continuing an interaction involving confrontation or friction between parties. This may be determined by algorithms running on the system 100 or the communication server 101. If it is found by the system 100 that the communication sent by the officer is appropriate, the communication may then be sent to the driver(s) at Block 1112. Otherwise, if it is determined by the system 100 that the officer's communication is found inappropriate, the officer may then be prompted and notified at Block 1142 that the communication is found inappropriate and the system 100 may request for the officer to either change the communication to be appropriate, send a new communication, or to select from a number of pre-made recommended communications that system 100 generated for the officer. For example, and without limitation, recommended communications may be communications developed by the system 100 or the communication server 101 based upon the present interaction or past interactions between the parties or other parties who were in the same type of interaction and the previous communications of the parties in the present interaction to either ask, answer, or respond to the prior communication(s) or initiate a new course of the conversation.

At Block 1134 it may be determined whether the officer has selected one of the recommended messages provide by the system 100. If it is determined the officer has selected one of the recommended messages from the system 100, then the communication may be sent to the driver at Block 1112. However, if it is determined that the officer did not select a suggested message, it may then be determined at Block 1136 if the officer sent a new communication in place of the inappropriate communication. If it is determined that the officer did send a new communication in place of the inappropriate communication, it may then be determined again at Block 1110 whether the communication sent by the officer is appropriate. If it is determined at Block 1136 that the officer did not send a new communication to replace the inappropriate communication, it may then be determined at Block 1138 if the officer requested to override the system 100 to send the communication flagged as inappropriate. If it is determined that the officer did not request an override, then the officer may be prompted again at Block 1142 to send a replacement communication or to select a communication from a number of suggested responses provided by the system 100. If it is determined that the officer requested to override the system 100 to send a communication flagged as inappropriate, then it may be determined at Block 1140 whether a third party agrees or disagrees to override the system 100 to send the inappropriate communication. If it is determined by the third party to approve the override of the system 100 to send the communication flagged as inappropriate, then the communication may be sent to the driver at Block 1112. However, if the third party does not approve of the override, then the officer may be prompted again at Block 1142 to either send a new communication or to select a suggested response provided by the system 100. The above steps may repeat until the officer either sends a communication found appropriate by the system 100, or when the officer sends a communication suggested by the system 100. Once a communication is sent by the officer at Block 1112 to the driver, it may then be determined by the system 100 or the parties if a reply is needed or requested from the driver at Block 1114. If it is determined that no reply is needed or requested then the method 1146 may end at Block 1144. If it is determined that a reply from the driver is needed or requested, then at Block 1116 the driver may be prompted by the system 100 to reply.

At Block 1118 it may be determined if the communication sent by the driver is appropriate. If it is found by the system 100 that the communication sent by the driver is appropriate, the communication may then be sent to the officer at Block 1120. Otherwise, if it is determined by the system 100 that the driver's communication is found inappropriate, the driver may then be prompted and notified at Block 1124 that the communication is found inappropriate and request for the driver to either change the communication to be appropriate or to select from a number of pre-made recommended responses that the system 100 may generate for the driver. At Block 1126 it may be determined whether the driver has selected one of the recommended messages provide by the system 100. If it is determined the driver has selected one of the recommended messages from the system 100, then the communication may be sent to the officer at block 1120. However, if it is determined that the driver did not select a suggested message, it may then be determined at Block 1128 if the driver sent a new communication in place of the inappropriate communication. If it is determined that the driver did send a new communication in place of the inappropriate communication, it may then be determined again at Block 1118 whether the communication sent by the driver is appropriate. If it is determined at Block 1128 that the driver did not send a new communication to replace the inappropriate communication, it may then be determined at Block 1130 if the driver requested to override the system 100 to send the communication flagged as inappropriate. If it is determined that the driver did not request an override, then the driver may be prompted again at Block 1124 to send a replacement communication or to select a communication from a number of suggested responses provided by the system 100. If it is determined that the driver requested to override the system 100 to send the communication flagged as inappropriate, then it may be determined at Block 1132 whether a third party agrees or disagrees to override the system 100 to send the inappropriate communication. If it is determined by the third party to approve the override of the system 100 to send the communication flagged as inappropriate, then the communication may be sent to the officer at Block 1120. However, if the third party does not approve of the override, then the driver may be prompted again at Block 1124 to either send a new communication or to select a suggested response provided by the system 100.

The above steps may repeat until the driver either sends a communication found appropriate by the system 100, or when the driver sends a communication suggested by the system 100. Once a communication is sent by the driver at Block 1120 to the officer, it may then be determined by the system 100 or the parties if a reply is needed or requested from the officer at Block 1122. If it is determined that no reply is needed or requested, the method 1146 may end at Block 1144. If it is determined that a reply from the officer is needed or requested, then at Block 1106 the officer may be prompted by the system 100 to reply. The above steps may repeat until it is determined at either Block 1114 or Block 1122 that a reply is not needed or requested from the parties. Then the method 1146 may end at Block 1144.

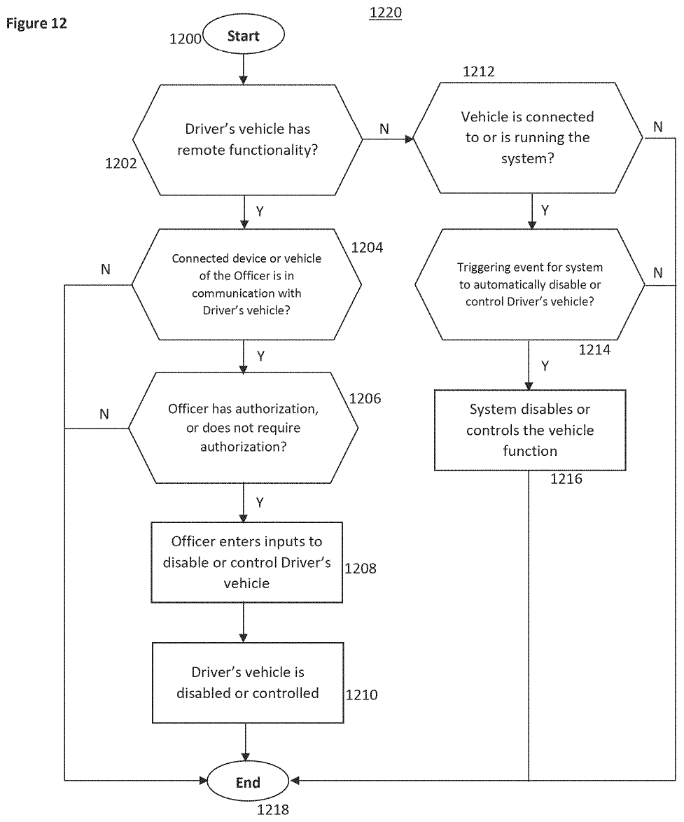

Now referring to FIG. 12, a method 1220 of the system 100 controlling the functions of a driver's vehicle 105 are now described in more detail. More specifically, FIG. 12 illustratively shows steps of a method 1220 for an officer, or the driver's device 103 or vehicle 105, to disable or control functions of the driver's vehicle 105 or other automobile with remote control functionality. From the start (Block 1200) it is first determined at Block 1202 whether the driver's vehicle 105 has remote functionality that would allow an officer to remotely control the vehicle's 105 functions. If it is determined that the driver's vehicle 105 does have remote functionality, then in Block 1204 it may be determined whether the officer's device 103 or vehicle 105 is in communication with the driver's vehicle 105. For example, and without limitation, this determination may be made by the system 100, communication server 101, or the officer's device 103 or vehicle 105 by detecting through the communication network 102 whether the driver's vehicle 105 is detected and connected to the communication network 102. If it is determined that the officer's device 103 or vehicle 105 is not in communication with the driver's vehicle 105, then the method 1220 may end at Block 1218. However, if it is determined that the officer's device 103 or vehicle 105 is in communication with the driver's vehicle 105, then at Block 1206 it may be determined whether the officer has authorization, or does not require authorization, to control the driver's vehicle 105.

If it is determined that the officer does not have authorization, or requires authorization that the officer does not have, then the method 1220 may end at Block 1218. Otherwise, if it is determined that the officer does not require authorization, or the officer does have authorization, at Block 1208 the officer may enter inputs into the system 100 to disable or control functions of the driver's vehicle 105. Then at Block 1210 the functions of the driver's vehicle 105 may be controlled or disabled by the officer's inputs into the system 100 and the method 1220 may end at Block 1218. If it is determined at Block 1202 that the driver' vehicle 105 does not have remote functionality, it may then be determined at Block 1212 if the vehicle 105 is connected to a device 103, or running the system 100. If it is determined that the vehicle 105 is connected to the system 100 or a device 103 that is connected to or running the system 100, it may be then determined at Block 1214 whether there is a triggering event that has taken place to automatically disable or control the driver's vehicle 105. For example, and without limitation, a triggering event detected by the driver's device 103 or vehicle 105 may be the device 103 or vehicle 105 detecting that the driver has begun to, or is attempting to, drive away from an interaction with an officer while a pullover is taking place. If there has been no triggering event, then the method 1220 may end at block 1218. However, if there was a triggering event, then the system 100 may disable or control the functions of the driver's vehicle 105, and the method may end at Block 1218.

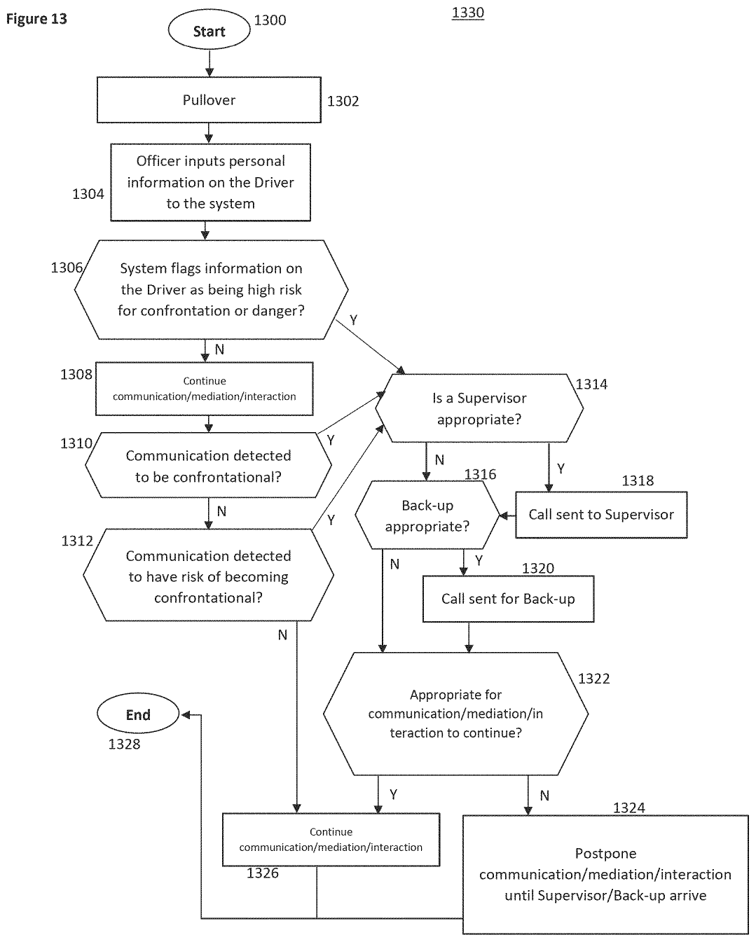

Now referring to FIG. 13, a method 1330 for the present invention to automatically call for back-up or a supervisor to come to the location to mediate or help the interaction is now discussed in more detail. From the start (Block 1300) there is a pullover at Block 1302, then at Block 1304 the officer will input information on the driver in the system 100, such as, but not limited to, the driver's license plate number. Then at Block 1306 it may be determined if, based on the user linked to the information inputted by the officer, the system 100 will analyze any information about that driver which may flag the driver at being high risk for causing a confrontational or dangerous situation. If it is determined that the driver is not flagged as a high risk for confrontation or danger by the system 100, then at Block 1308 the communication, mediation, and interaction may continue between the parties. Then at Block 1310 it may be determined whether the system 100 detects that the communication to be confrontational. If it is determined that the communication between the parties may be confrontational, then at Block 1314 it may be determined whether it is appropriate to call a supervisor to come to the interaction to help mediate. However, if at Block 1310 it is determined that the communication is not confrontational, it is then determined at Block 1312 whether the communication is detected to have a risk of creating a confrontational interaction.

If it is detected that the communication has a risk of creating a confrontational interaction, then at Block 1314 it may be determined whether it is appropriate to call a supervisor to the interaction to help mediate. If it is determined appropriate to call a supervisor to the scene then at Block 1320 the system 100 may call or notify a supervisor to either arrive to the scene or provide additional mediation through a compatible electronic device, such as a device 103, vehicle 105, phone, or personal computer. However, if at Block 1314 it is determined that a supervisor if not appropriate, then at Block 1316 it may be determined by the system 100 whether it is appropriate for law enforcement back-up to be called. If it is determined appropriate to call for back-up, then at Block 1320 the system 100 may call for law enforcement back-up to arrive to the scene. However, if at Block 1316 it is determined that calling back-up is not appropriate, then at Block 1322 it is determined whether it is appropriate for the communication and mediation to continue. If it is determined that it is not appropriate for the communication and mediation to continue, then at Block 1324 the communication and mediation may be postponed until the supervisor and/or back-up arrive at the scene. However, if at Block 1322 it is determined that it is appropriate for the communication and mediation to continue then at Block 1326 the communication, mediation, and interaction between the parties may continue whether or not a supervisor or back-up are on the way to the scene of the interaction. Then the method 1334 may end at Block 1332.

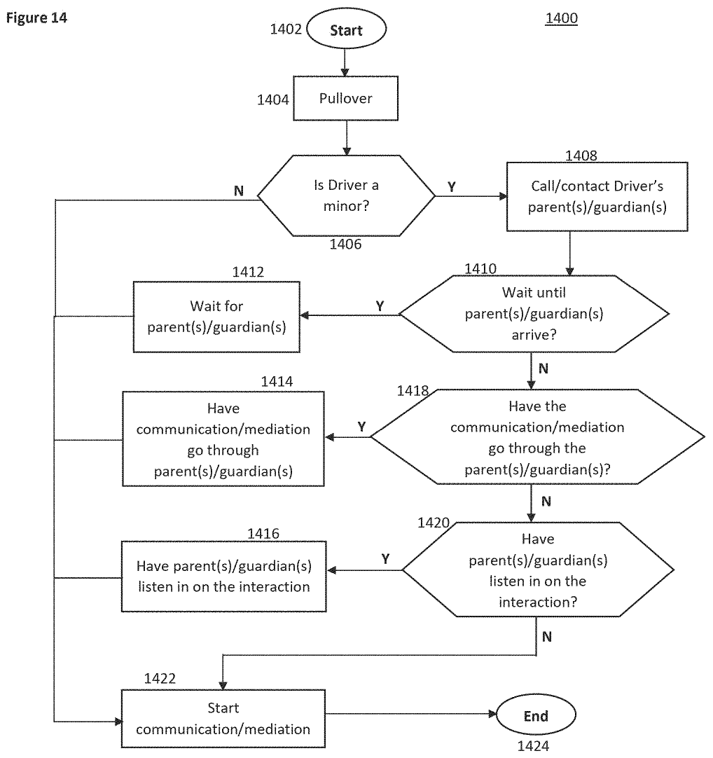

Now referring to FIG. 14, a method 1400 for calling or contacting a minor's parent or guardian in the case of a pullover of the minor by a police officer. From the start (Block 1402) a pullover takes place at Block 1404, then at Block 1406 the system 100 may determine whether the driver is a minor. If it is determined that the Driver is not a minor, then the method 1400 ends at block 1424. However, if the system 100 determines that the Driver is a minor, then at Block 1408 the system 100 may call or contact the Driver's parent(s) or guardian(s). Next, at Block 1410 the system 100 may determine whether it is appropriate to wait to start the communication and mediation without the parent(s) or guardian(s) present at the interact. If the system 100 determines that it is appropriate to wait until the Driver's parent(s) or guardian(s) arrive to begin the communication and mediation, at Block 1412 the system 100 may prompt all the parties of the interaction to wait until the Driver's parent(s) or guardian(s) arrive to the scene before starting the communication and mediation. However, if it is determined at Block 1410 that it is not appropriate to wait for the parent(s) or guardian(s) to arrive, at Block 1418 the system 100 may determine whether to instead have the communication and mediation to take place through the parent(s) or guardian(s) of the driver with the officer. If it is determined that the communication and mediation should go through the parent(s) or guardian(s) of the Driver, then at Block 1414 the system may configure to have the communication and mediation should go through the parent(s) or guardian(s) of the Driver and may begin the communication and mediation at Block 1422. For example, and without limitation, the communication and mediation going through the parent(s) or guardian(s) of the driver may happen by the communications first going to the parent(s) or guardian(s) and then to the driver, or the communication to the officer may go to both the parent(s) or guardian(s) and the driver, but the parent(s) or guardian(s) are the only one(s) allowed to respond to the officer's communications because the driver's capability to do so will be disabled. However, if the system 100 determines that it is not appropriate for the communication and mediation to go through the parent(s) or guardian(s) of the Driver, then at Block 1420 the system 100 may determine whether it is appropriate to have the parent(s) or guardian(s) listen in on the interaction between the Driver and the officer. If this is determined appropriate, then at Block 1416 the system may allow the parent(s) or guardian(s) to listen in on the communications between the parties, and the system 100 may also give the parent(s) or guardian(s) the option to join in on the communications between the parties. However, if it is determined at Block 1420 that it is not appropriate for the parent(s) or guardian(s) to listen in on the interaction, then at Block 1422 the communication and mediation of the system 100 between the Driver and officer may begin without the parent(s) or guardian(s) involved, and the method 1400 may then end at Block 1424.

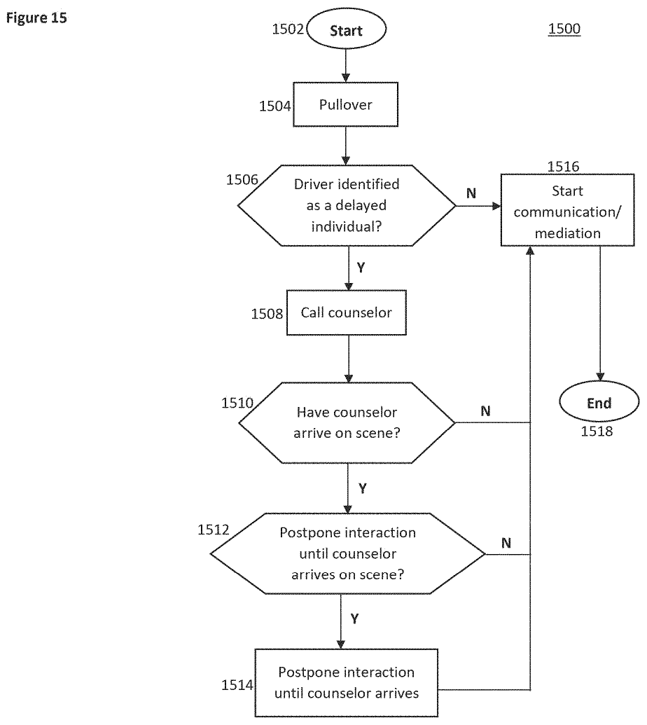

Now referring to FIG. 15, the method 1500 for calling a counselor to help an interaction between a developmentally delayed individual and an officer is now described. More specifically, FIG. 15 illustratively shows the steps of method 1500 for the system 100 to contact a counselor for an individual considered developmentally delayed for an interaction between that individual and an officer during a pullover. From the start (Block 1502) a pullover may take place at block 1504. Then at block 1506 it is determined whether the driver is identified as a delayed individual. If it is determined that the driver is not a delayed individual, then at Block 1516 communication and mediation may start between the parties and the system 100 and the method 1500 may end at Block 1518.

However, if it is determined at Block 1506 that the driver is not identified as a delayed individual then at block 1508 a counselor for the driver may be called or contacted. Then at Block 1512 it is determined whether it is appropriate for the counselor to arrive to the scene of the interaction. If it is determined that it is not appropriate for the counselor to arrive to the scene then communication and mediation between the parties begins with either the counselor being virtually present through phone, video, or other virtual means or the counselor can choose to not be involved in the interaction and may leave the communication and mediation between the parties to be handled only through the system 100 at Block 1516 between the driver and officer. However, if at Block 1510 it is determined that it is appropriate for the counselor to arrive to the scene of the interaction then at Block 1512 the system 100 may determine whether it is appropriate for the interaction, communication and mediation to be postponed until the counselor arrives to the scene. If it is determined that it is not necessary to postpone the interaction, then at Block 1516 the communication and mediation may begin before the counselor is physically present at the scene. However, if at block 1512 it is determined that it is appropriate for the interaction to not take place until the counselor arrives at the scene, then at Block 1514 the system may notify the parties that interaction and the communication and mediation may not be available until the counselor arrives to the scene of the interaction. Then at Block 1516 the communication and mediation may start once the counselor arrives at the scene. Thereafter, the method 1500 may end at Block 1518.

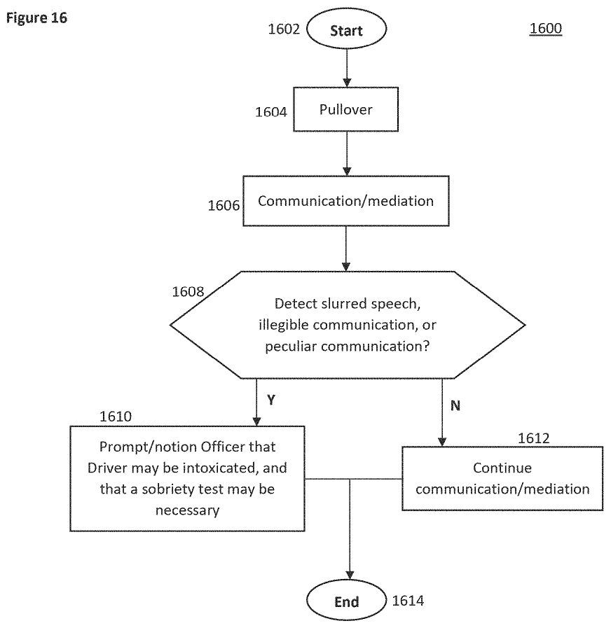

Now referring to FIG. 16, the method 1600 for detecting and notifying an officer if a driver is likely intoxicated is now described. From the start (Block 1602) a pullover may take place at Block 1604. Then at Block 1606 the interaction may being with communication and mediation by the system 100. Then at Block 1608 the system 100 may determine whether it has detected the driver displaying slurred speech or has made illegible or peculiar communications to the officer. If it is determined that the driver has be detected doing any of these actions, then at Block 1610 the system 100 may prompt and notify the officer that the driver has been detected exhibiting intoxicating behavior and may make a recommendation to the officer to take a sobriety test of the driver. However, if it is determined at Block 1608 that the driver has not exhibited any behavior indicating possible intoxication, then at Block 1612 the communication and mediation of the interaction by the system 100 may continue without interruption. Then the method 1600 may end at Block 1614.

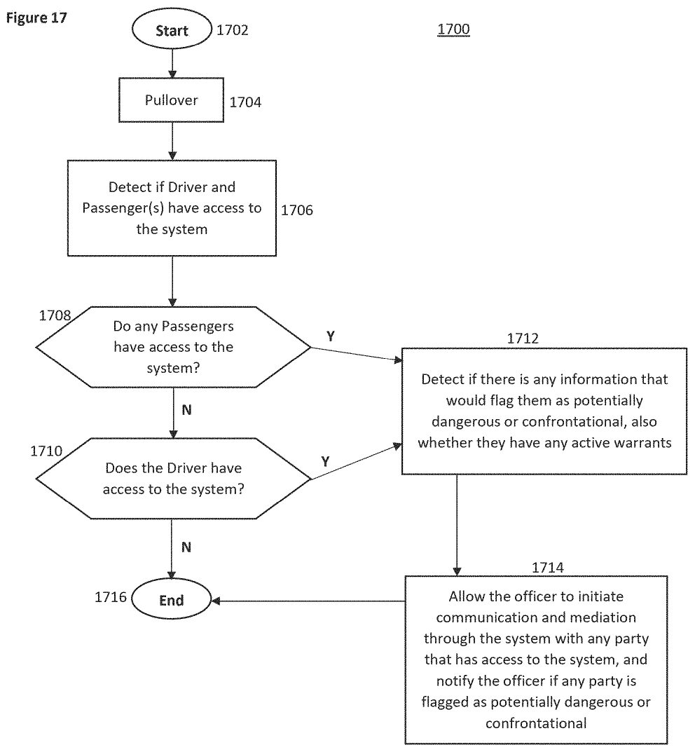

Now referring to FIG. 17, the method 1700 for the system 100 to interact and screen passengers of a driver is now described. At the start (Block 1702) a pullover may take place at Block 1704. Then at Block 1706 the system may begin to detect if the driver or any passengers in the vehicle have access to the system. At block 1708 it is determined whether any of the passengers of the vehicle have access to the system. If it is determined by the system 100 that there are passengers with access to the system 100 then at Block 1712 the system 100 may review any information it has pertaining to each passenger to determine if there is any information that may flag that individual as a person who is potentially dangerous or likely to cause confrontation with the officer or others. For example, without limitation, information that may flag an individual as potentially confrontational or dangerous may be a prior arrest history, an active warrant, a history of domestic abuse, a history of assault, a history of battery, or other criminal history. Then at block 1714 that system 100 may allow the officer to initiate communication with any party who has access to the system 100 and the system 100 may also notify the officer if any party has been flagged for having a high risk of being dangerous or causing a confrontational situation. Then the method 1700 may end at Block 1716.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for communication facilitation between parties to an interaction, the system comprising:
at least two communication devices each comprising at least one of a speaker, a microphone, a display, a camera, and an input interface; and
a communication server in communication with the at least two communication devices so that each of the communications devices are in communication with one another via the server, the communication server having a server database storing information regarding at least one user of the at least two communication devices;
wherein at least one of the at least two communication devices determines when the at least one user is pulled over by law enforcement;
wherein upon determining that the at least one user is pulled over by law enforcement, the communication server transmits at least a portion of the information to at least one of the communication devices; and
wherein the communication server monitors and mediates the communication between the at least two communication devices.
